(19) United States
(12) Patent Application Publication
(10) Pub. No.: US 2025/0199937 A1
(43) Pub. Date: Jun. 19, 2025

(54) ANOMALY DETECTION DEVICE AND METHOD THEREOF

(71) Applicant: INDUSTRIAL TECHNOLOGY RESEARCH INSTITUTE, Hsinchu (TW)

(72) Inventor: Tzu-Chieh Shen, Taoyuan City (TW)

(73) Assignee: INDUSTRIAL TECHNOLOGY RESEARCH INSTITUTE, Hsinchu (TW)

(21) Appl. No.: 18/659,141

(22) Filed: May 9, 2024

(30) Foreign Application Priority Data
Dec. 13, 2023 (TW) 112148596

(51) Int. Cl. G06F 11/34

(52) U.S. Cl. CPC G06F 11/3452; G06F 11/3423

(57) ABSTRACT

An anomaly detection device, used to detect a first anomaly state and a second anomaly state of an application program, which includes the following elements. A data amount accumulating unit, for accumulating a first data amount processed by the application program. An operating time counter, for accumulating a first count value according to a first counting frequency. An anomaly state counter, for selectively accumulating a second count value according to the first anomaly state. A monitoring unit, for monitoring whether the first data amount reaches a predefined data amount. When the first data amount reaches the predefined data amount, determining whether the application program is in the first abnormal state according to the first count value. When the application program is in the first anomaly state, accumulating the second count value and determining the application program as in the second abnormal state according to the second count value.

This application program claims the benefit of Taiwan application Serial No. 112148596, filed Dec. 13, 2023, the present disclosure of which is incorporated by reference herein in its entirety.

### TECHNICAL FIELD

The present disclosure relates to a data processing device and a method thereof, and in particular relates to an anomaly detection device and a method thereof for detecting an anomaly state of an application program.

### BACKGROUND

In satellite systems and network communication systems, numerous application programs are installed and executed to perform system operations. Computing resources of the satellite systems and the network communication systems (e.g., utilization of the processor and usage and bandwidth of the memory, etc.) are allocated to these application programs.

When allocation of the computing resources cannot adapt to realistic operation of the system, the computing resources may be heavily occupied by some specific application programs, which causes the application programs dedicated for communication functions in the system fail to obtain sufficient computing resources (i.e., referred to as “computing resource crowding”). Under this situation, such application programs dedicated for communication functions cannot process current data amount within a predefined time (i.e., it cannot achieve predefined data throughput), resulting in communication interrupts of the satellite system or degradation of the transmission quality of the network communication system.

Existing satellite systems and network communication systems often use watchdog timers to monitor the operation time of application programs, so as to determine whether the application program may process the predefined data amount within the predefined time. However, both hardware and software watchdog counters have their shortcomings and limitations and cannot effectively detect short-term mild anomalies in systems and application programs.

In view of the above issues, an improved anomaly detection mechanism is needed, which may effectively detect short-term mild anomalies and long-term severe anomalies.

### SUMMARY

According to one embodiment of the present disclosure, an anomaly detection device is provided. The anomaly detection device is for detecting an anomaly in a usage state of an application program for a computing resource, the anomaly in the usage state comprises a first anomaly state and a second anomaly state. The anomaly detection device comprises the following elements. A data amount accumulation unit, for accumulating a first data amount processed by the application program. An operation time counter, having a first count value and accumulating the first count value according to a first counting frequency. An anomaly state counter, having a second count value and selectively accumulating the second count value according to the first anomaly state. A monitoring unit, for performing the following operations. Monitoring whether the first data amount reaches a predefined data amount, wherein the predefined data amount is related to a maximum processing rate of the application program. When the first data amount reaches the predefined data amount, reading the first count value and determining whether the application program is in the first anomaly state according to the first count value. When it is determined that the application program is in the first anomaly state, accumulating and reading the second count value, and determining whether the application program is in the second anomaly state according to the second count value.

According to another embodiment of the present disclosure, an anomaly detection method is provided. The anomaly detection method is for detecting an anomaly in a usage state of an application program for a computing resource, the anomaly in the usage state comprises a first anomaly state and a second anomaly state. The anomaly detection method comprising the following steps. Accumulating a first data amount processed by the application program, by a data amount accumulation unit. Accumulating a first count value according to a first counting frequency, by an operation time counter. Selectively accumulating a second count value according to the first anomaly state, by an anomaly state counter. Performing the following operations by a monitoring unit. Monitoring whether the first data amount reaches a predefined data amount, wherein the predefined data amount is related to a maximum processing rate of the application program. When the first data amount reaches the predefined data amount, reading the first count value and determining whether the application program is in the first anomaly state according to the first count value. When it is determined that the application program is in the first anomaly state, accumulating and reading the second count value, and determining whether the application program is in the second anomaly state according to the second count value.

### BRIEF DESCRIPTION OF THE DRAWINGS

FIG. 1, which is a schematic diagram of an anomaly detection device applied to a computer system platform according to an embodiment of the present disclosure.

FIG. 2, which illustrates a block diagram of the anomaly detection device and illustrates the operation of the anomaly detection device.

FIG. 3 illustrates a flow chart of an anomaly detection method according to an embodiment of the present disclosure.

FIG. 4 illustrates a flow chart of an anomaly detection method according to another embodiment of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

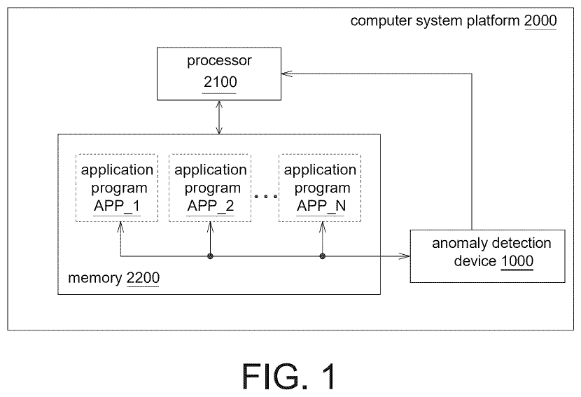

Please refer to FIG. 1, which is a schematic diagram of an anomaly detection device 1000 applied to a computer system platform 2000 according to an embodiment of the present disclosure. The computer system platform 2000 includes a processor 2100 and a memory 2200. Several application programs (e.g., N's application programs APP_1 to APP_N) operate in the computer system platform 2000. During operation, the application programs APP_1 to APP_N may be temporarily stored in the memory 2200, and the processor 2100 and memory 2200 provide computing resources for the application programs APP_1 to APP_N. According to realistic operation conditions, the computing resources are allocated to the application programs APP_1 to APP_N. The computing resources include, e.g., the usage and utilization of the processor 2100, and the usage, bandwidth and access efficiency of the memory 2200, and the bandwidth of the bus, etc. Taking the application program APP_1 as an example, it uses the above computing resources for data processing. The data processing rate R1 of the application program APP_1 is defined as: the data amount generated per unit time, which may be referred to as: the data traffic amount per unit time, the data throughput or the network traffic amount. For example, the network traffic amount is the average data amount successfully transmitted per unit time on a communication channel (including physical links or logical links), or the average data amount passing through a certain network node. The units of the above-mentioned data traffic amount, data throughput or network traffic amount may be expressed as: bits per second (i.e., bit/s or bps). The data processing rate R1 of application program APP_1 is positively proportional to the ratio of computing resources allocated to application program APP_1 (or the utilization rate of computing resources by application program APP_1). When the allocation ratio or the utilization rate of the computing resources for the application program APP_1 is high, the data processing rate R1 of the application program APP_1 is greater.

The anomaly detection device 1000 is used to detect anomalies in the usage state of each of the application programs APP_1 to APP_N for the computing resources. The anomaly state comprises: one of the application programs APP_1 to APP_N fails to process and generate a predefined amount of data within a predefined time, or its data traffic amount, data throughput or network traffic amount is abnormal. In one example, the anomaly detection device 1000 may be a set of software program installed and executed in the computer system platform 2000. In another example, the anomaly detection device 1000 may be an independent hardware component in the computer system platform 2000, such as a micro-processor or an application specific integrated circuit (ASIC).

In the following paragraphs, it still takes the application program APP_1 as an example for describing. The anomaly in the usage state of the application program APP_1 for the computing resources, may comprise a first anomaly state S_AB1 and a second anomaly state S_AB2. The first anomaly state S_AB1 indicates that, the usage state of the application program APP_1 for the computing resources is a short-term anomaly or a mild anomaly. For example, the utilization rate of the application program APP_1 for the computing resources does not reach the predefined utilization rate in a short-term period. The second anomaly state S_AB2 indicates that, the usage state of the application program APP_1 for the computing resources is a long-term anomaly or a severe anomaly. For example, the utilization rate of the application program APP_1 for the computing resources is continuously lower than the predefined utilization rate for a long-time period.

In one example, the anomaly detection device 1000 may determine whether the application program APP_1 is in the anomaly state according to the current data processing rate R1 of the application program APP_1. When the data processing rate R1 reaches the maximum processing rate R_max, it means that the application program APP_1 is allocated with sufficient computing resources (i.e. the utilization rate for the computing resources reaches the predefined utilization rate), and the anomaly detection device 1000 determines that the application program APP_1 is in a normal state. On the contrary, when the data processing rate R1 does not reach the maximum processing rate R_max, it means that the application program APP_1 does not obtain sufficient computing resources, and the application program APP_1 is determined as in the anomaly state.

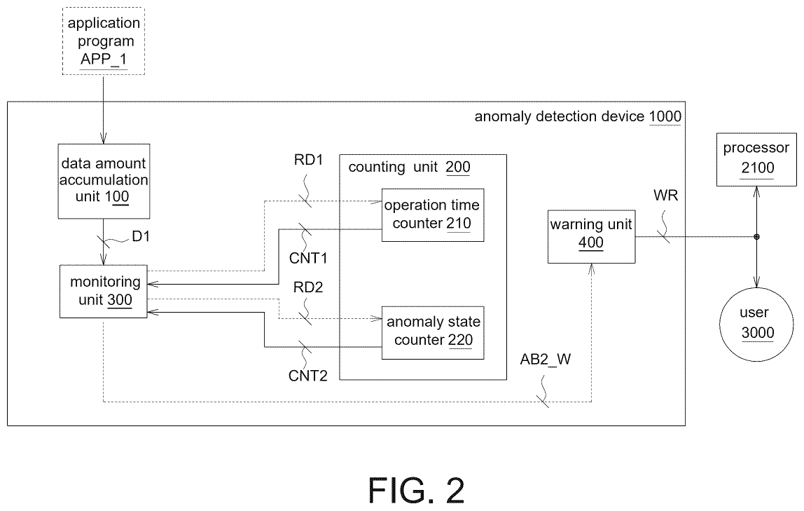

Please refer to FIG. 2, which illustrates a block diagram of the anomaly detection device 1000 and illustrates the operation of the anomaly detection device 1000. The anomaly detection device 1000 includes a data amount accumulation unit 100, a counting unit 200, a monitoring unit 300 and a warning unit 400, which are respectively software modules or hardware circuits inside the anomaly detection device 1000. For example, the data amount accumulation unit 100 is an embedded device, the counting unit 200 is a software counting program or a hardware digital counting circuit, and the counting unit 200 further includes an operation time counter 210 and an anomaly state counter 220. The monitoring unit 300 is a monitoring software or hardware monitoring circuit. The warning unit 400 may be a hardware circuit that provides a sound signal or a light signal. The basic operation of the anomaly detection device 1000 is described below.

The data amount accumulation unit 100 is used to accumulate the first data amount D1 processed and generated by the application program APP_1 using the computing resources. If the application program APP_1 takes a first operation time T1 to process and generate the first data amount D1, the first data amount D1 is equal to the first operation time T1 multiplied by the data processing rate R1 of the application program APP_1.

The monitoring unit 300 monitors the first data amount D1 of the application program APP_1. When the first data amount D1 reaches the predefined data amount, the monitoring unit 300 sends a control signal RD1 to the operation time counter 210, so as to read the first count value CNT1 of the operation time counter 210. The first count value CNT1 is accumulated according to the first counting frequency F1 of the operation time counter 210, and the read first count value CNT1 is positively proportional to the first operation time T1. That is, the operation time counter 210 may be used to estimate the first operation time T1 of the application program APP_1.

When the first data amount D1 reaches the predefined data amount, the monitoring unit 300 determines whether the application program APP_1 is in the first anomaly state S_AB1 according to the read first count value CNT1. When the application program APP_1 is determined to be in the first anomaly state S_AB1, the monitoring unit 300 sends the control signal RD2 to the anomaly state counter 220.

The second count value CNT2 of the anomaly state counter 220 is selectively accumulated according to the first anomaly state S_AB1. When the anomaly state counter 220 receives the control signal RD2, it accumulates the second count value CNT2 and reads the second count value CNT2. In other words, the second count value CNT2 is equal to the number of occurrences of the first anomaly state S_AB1 (i.e., the number of times the application program APP_1 is determined as in the first anomaly state S_AB1). That is, the anomaly state counter 220 may be used to estimate the number of occurrences of the first anomaly state S_AB1 of the application program APP_1. Furthermore, the monitoring unit 300 determines whether the application program APP_1 is in the second anomaly state S_AB2 according to the read second count value CNT2.

The warning unit 400 is used to selectively issue a warning signal WR. For example, when the monitoring unit 300 determines that the application program APP_1 is in the second anomaly state S_AB2, the monitoring unit 300 sends the control signal AB2_W to the warning unit 400, and the warning unit 400 issues the warning signal WR in response to the control signal AB2_W. The warning signal WR may be sent to the processor 2100 to prompt the processor 2100 to re-adjust the allocation of computing resources. The warning signal WR may also be a sound signal or a light signal to prompt the user 3000.

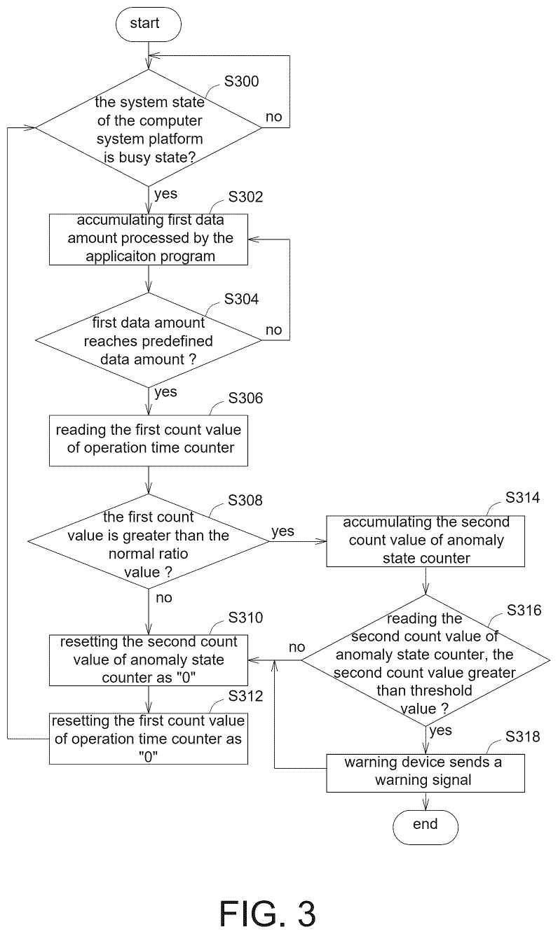

FIG. 3 illustrates a flow chart of an anomaly detection method according to an embodiment of the present disclosure. The anomaly detection method is performed by the anomaly detection device 1000. Please refer to FIGS. 2 and 3, the detailed operation of the anomaly detection device 1000 will be explained. First, step S300 is performed: the anomaly detection device 1000 analyzes the system state of the computer system platform 2000 and determines whether the system state is the busy state S_BUSY. If it is not the busy state S_BUSY, return to step S300. If the anomaly detection device 1000 analyzes that the application program APP_1 continuously receives/transmits a predefined number of packets (for example, 30 packets), it determines that the system state is the busy state S_BUSY, and then executes step S302: accumulating the first data amount D1 that application program APP_1 has processed, by the data amount accumulation unit 100. The first data amount D1 is related to (e.g., positively proportional to) the data processing rate R1 of the application program APP_1. When the data processing rate R1 is greater, the first data amount D1 is greater.

Next, step S304 is executed: the monitoring unit 300 determines whether the first data amount D1 reaches the predefined data amount DO. The predefined data amount DO is related to the maximum processing rate R_max of the application program APP_1. The monitoring unit 300 may set the predefined data amount D0 according to the maximum processing rate R_max. Such as, firstly, calculating a quotient of the maximum processing rate R_max divided by the first counting frequency F1 of the operation time counter 210. This quotient is equal to the second data amount D2. Furthermore, setting a normal ratio value N1 of the operation time counter 210. Moreover, calculating a product of the second data amount D2 and the normal ratio value N1. This product is equal to the predefined data amount D0, as shown in equation (1).

$$D 0 = D 2 \times N 1 = ( R\_max / F 1 ) \times N 1 \qquad ( 1 )$$

In one example, the application program APP_1 is an Ethernet driver of an Ethernet communication device, and the maximum processing rate R_max of the application program APP_1 is, e.g., 1000 Mbps. Furthermore, the first counting frequency F1 of the operation time counter 210 is, e.g., 100 Hz. When the normal ratio value N1 is set as “1”, the predefined data amount DO is 10 Mb. The normal ratio value N1 may also be set as other positive integers, e.g., “2”, “3”, . . . , “10”, etc. When the normal ratio value N1 is set as “5”, the predefined data amount D0 is 50 M.

If the determination result in step S304 is that, the first data amount D1 does not reach the predefined data amount DO, then return to step S302: continue to accumulate the first data amount D1 that has been processed by the application program APP_1. If the determination result of step S304 is that, the first data amount D1 has reached the predefined data amount DO, then step S306 is executed: the monitoring unit 300 reads the first count value CNT1 of the operation time counter 210.

Next, step S308 is executed: the monitoring unit 300 compares the read first count value CNT1 (i.e., the first count value CNT1 which is read when the first data amount D1 reaches the predefined data amount DO) with the normal ratio value N1. If the first count value CNT1 is greater than the normal ratio value N1, it means that the first operation time T1 spent by the application program APP_1 to process and generate the first data amount D1 exceeds the normal operation time TO for the normal state (i.e., the first operation time T1 of the application program APP_1's has expired). The normal operation time TO is equal to the quotient of the normal ratio value N1 divided by the first counting frequency F1 of the operation time counter 210, as shown in equation (2).

$$T 0 = N 1 / F 1 \qquad ( 2 )$$

In other words, it may determine whether the first operation time T1 of the application program APP_1 exceeds the normal operation time TO by comparing whether the first count value CNT1 is greater than the normal ratio value N1. When the first count value CNT1 is greater than the normal ratio value N1, it means that the application program APP_1 fails to reach the maximum processing rate R_max and causes the first operation time T1 to expire. The failure for the application program APP_1 to reach the maximum processing rate R_max is due to: the utilization rate of the application program APP_1 for the computing resources has not reached the predefined utilization rate. Therefore, it is determined that the application program APP_1 is in the first anomaly state S_AB1 (i.e., usage state of the application program APP_1 is determined as short-term anomaly or mild anomaly).

If the first count value CNT1 is greater than the normal ratio value N1 in step S308, it is determined that the application program APP_1 is in the first anomaly state S_AB1, and then step S314 is performed: accumulating the second count value CNT2 of the anomaly state counter 220. In other words, the second count value CNT2 is equal to the number of times that the application program APP_1 is determined to be in the first anomaly state S_AB1. Next, step S316 is executed: the monitoring unit 300 reads the second count value CNT2 of the anomaly state counter 220 and compares the second count value CNT2 with the threshold value AB1_TH. When the second count value CNT2 is greater than the threshold value AB1_TH, it means that the application program APP_1 has been determined as in the first anomaly state S_AB1 for many times, and the application program APP_1 is no longer involved with a short-term anomaly or a mild anomaly, but a long-term anomaly or a severe anomaly. Therefore, the monitoring unit 300 determines that the application program APP_1 is in the second anomaly state S_AB2. Next, step S318 is executed: the warning unit 400 sends the warning signal WR to the processor 2100 and/or the user 3000. After step S318, step S310 is executed: resetting the second count value CNT2 of the anomaly state counter 220 as “O”. Then, step S312 is executed: resetting the first count value CNT1 of the operation time counter 210 as “0”. Then, steps S300 to S316 are executed again, and the anomaly detection device 1000 re-detects whether the subsequent operations of the application program APP_1 are abnormal.

On the other hand, in step S308, if the first count value CNT1 is less than or equal to the normal ratio value N1, it is determined that the application program APP_1 is in the normal state, and then step S310 is performed: resetting the second count value CNT2 of the anomaly state counter 220 as “O”. Similarly, in step S316, if the second count value CNT2 is less than or equal to the threshold value AB1_TH, it means that the number of occurrences of the first anomaly state S_AB1 of the application program APP_1 is still small, and it is still a short-term anomaly or a mild anomaly (or, the application program APP_1 is in the first anomaly state S_AB1 only for a short period, but then returns to the normal state). Next, step S310 is executed: resetting the second count value CNT2 of the anomaly state counter 220 as “0”.

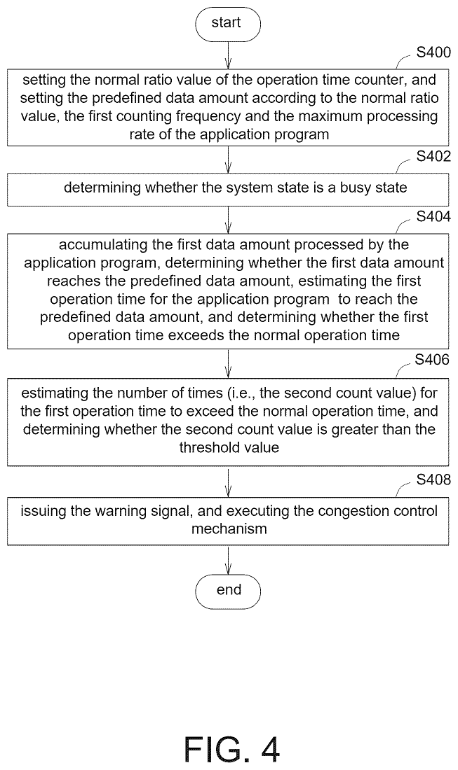

FIG. 4 illustrates a flow chart of an anomaly detection method according to another embodiment of the present disclosure. Please refer to FIGS. 2 and 4, step S400 is firstly performed: the anomaly detection device 1000 sets the normal ratio value N1 of the operation time counter 210, and sets the predefined data amount DO according to the maximum processing rate R_max of the application program APP_1, the first counting frequency F1 of the operation time counter 210 and the normal ratio value N1 (see equation (1)). For example, when the maximum processing rate R_max of the application program APP_1 is 1000 Mbps, the first counting frequency F1 is 100 Hz, and the normal ratio value N1 is set as “1”, the predefined data amount D0 is set as 10 Mb.

Next, step S402 is executed: determining whether the system state of the computer system platform 2000 is the busy state S_BUSY. Next, step S404 is executed: accumulating the first data amount D1 that has been processed by the application program APP_1, and determining whether the first data amount D1 reaches the predefined data amount DO. If the predefined data amount DO has been reached, estimating the first operation time T1 for the application program APP_1 to reach the predefined data amount DO, and determine whether the first operation time T1 exceeds the normal operation time TO (i.e., whether the application program APP_1 times out). If the first operation time T1 exceeds the normal operation time TO, it is determined that the application program APP_1 is in the first anomaly state S_AB1.

Next, step S406 is executed: estimating the number of times for the first operation time T1 to exceed the normal operation time TO. For example, the second count value CNT2 of the anomaly state counter 220 indicates the number of times for the first operation time T1 to exceed the normal operation time TO. Furthermore, determining whether the second count value CNT2 is greater than the threshold value AB1_TH. If the second count value CNT2 is greater than the threshold value AB1_TH, it is determined that the application program APP_1 is in the second anomaly state S_AB2, and step S408 is executed.

In step S408, the warning unit 400 sends the warning signal WR to the processor 2100 or the user 3000. In response to the warning signal WR, the processor 2100 executes a congestion control mechanism to adjust the allocation of computing resources, such that the application program APP_1 may obtain sufficient computing resources. In response to different types of application program APP_1, different congestion control mechanisms may be adopted, e.g., those adapted to communication transmission protocols.

In the anomaly detection methods in FIGS. 3 and 4, the threshold value AB1_TH may be adjusted according to different application scenarios or different operation conditions. For example, when the application program APP_1 operates in a mass data transmission (e.g., the FTP transmission), or transmitting high data amount of messages for a long-term period, the threshold value AB1_TH is adjusted as a greater value. When the application program APP_1 operates to transmit low data amount of messages in a short-term period (e.g., voice calls), the threshold value AB1_TH is adjusted to a smaller value.

In addition, the threshold value AB1_TH may also be adjusted according to an update frequency F_S of the system state of the computer system platform 2000. The threshold value AB1_TH may be adjusted as greater than a number of times corresponding to the update frequency F_S. For example, if the update frequency F_S is 10 Hz, the threshold value AB1_TH is adjusted as “11”. In one example, when the system state of the computer system platform 2000 switches to a lightly state S_LIGHT, the data throughput of the computer system platform 2000 naturally decreases due to low data amount of the lightly state S_LIGHT, causing the data amount generated by the application program APP_1 also naturally decreases. That is, in lightly state S_LIGHT, the decrease in the data amount of the application program APP_1 is not due to the anomaly state. Therefore, the threshold value AB1_TH may be increased such that the second count value CNT2 will not exceed the threshold value AB1_TH when transitioning to the lightly state S_LIGHT, and the application program APP_1 will not be determined as in the second anomaly state S_AB2. Moreover, when the computer system platform 2000 switches from the busy state S_BUSY to the lightly state S_LIGHT, the second count value CNT2 is reset as “0”.

In summary, the anomaly detection device 1000 and the anomaly detection method disclosed in the present disclosure may be applied to a low orbit satellite communication systems (LEO) to effectively detect short-term anomalies and long-term anomalies in the software of satellite devices, so as to avoid misjudgment of anomalies for software, which may cause frequent resetting for the satellite devices and lead to interrupts in communications. Alternatively, the anomaly detection device 1000 may be applied to an embedded communication network system, e.g., a core network server of the 4G LTE or the 5G NR communication systems, so as to detect anomalies in the software of the network server and to avoid misjudgment of anomalies for software, which may cause frequent resetting for the network server in the telecommunication controlling room and affect communication performance.

In a comparative example, “Rule-base” is used to detect whether the application program is abnormal, by using logical inferences, established rules, and added environmental variables. Which is, detecting and inferring the operating behavior of the application program (including the computing resources and operation time required for its operation). If the operating behavior complies with the inference rules, the application program is determined to be normal. However, the anomaly detection mechanism of the above comparative example has the following disadvantages: it is difficult to handle large-scale, high-complexity, high-dimensional and non-structural operation behaviors of the application program.

Moreover, in another comparative example, a watchdog timer (WDT) is disposed for anomaly detection. However, in the system platform, there are at most two sets of hardware watchdog counters. Such a small number (i.e., “2”) of hardware watchdog counters cannot detect many software drivers or application programs at the same time. Even though a software watchdog counter may be utilized, it may only set a single timing period, which cannot perform multiple accumulations for anomaly states, and it is difficult to detect short-term anomalies between the predefined time period and the counting period.

Compared with the above two comparative examples, the anomaly detection device 1000 and the anomaly detection method in the present disclosure may simply and effectively detect the anomaly states of the application programs APP_1 to APP_N in the busy state S_BUSY of the computer system platform 2000. Moreover, the first anomaly state S_AB1 (i.e., the short-term anomaly) of the application programs APP_1 to APP_N may be detected before the watchdog counter is triggered, hence, it may avoid interrupts of operation caused by frequent resetting of the computer system platform 2000.

It will be apparent to those skilled in the art that various modifications and variations may be made to the disclosed embodiments. It is intended that the specification and examples be considered as exemplars only, with a true scope of the present disclosure being indicated by the following claims and their equivalents.

What is claimed is:

1. An anomaly detection device, for detecting an anomaly in a usage state of an application program for a computing resource, the anomaly in the usage state comprises a first anomaly state and a second anomaly state, the anomaly detection device comprising:
a data amount accumulation unit, for accumulating a first data amount processed by the application program;
an operation time counter, having a first count value and accumulating the first count value according to a first counting frequency;
an anomaly state counter, having a second count value and selectively accumulating the second count value according to the first anomaly state; and
a monitoring unit, for performing the following operations:
monitoring whether the first data amount reaches a predefined data amount, wherein the predefined data amount is related to a maximum processing rate of the application program;
when the first data amount reaches the predefined data amount, reading the first count value and determining whether the application program is in the first anomaly state according to the first count value; and
when it is determined that the application program is in the first anomaly state, accumulating and reading the second count value, and determining whether the application program is in the second anomaly state according to the second count value.

2. The anomaly detection device according to claim 1, wherein the first anomaly state indicates a short-term anomaly or a mild anomaly of the usage state, and the second anomaly state indicates a long-term anomaly or a severe anomaly of the usage state.

3. The anomaly detection device according to claim 1, wherein:
the monitoring unit sets a normal ratio value of the operation time counter;
when the first data amount reaches the predefined data amount, the monitoring unit compares the first count value with the normal ratio value; and
when the first count value is greater than the normal ratio value, the monitoring unit determines that the application program is in the first anomaly state.

4. The anomaly detection device according to claim 3, wherein when the first count value is less than or equal to the normal ratio value, the application program reaches the maximum processing rate, and the monitoring unit determines that the application program is in a normal state.

5. The anomaly detection device according to claim 3, wherein the predefined data amount is equal to the maximum processing rate divided by the first counting frequency and then multiplied by the normal ratio value.

6. The anomaly detection device according to claim 5, wherein the monitoring unit estimates the maximum processing rate according to a statistical data of the application program.

7. The anomaly detection device according to claim 3, wherein:
the monitoring unit sets a threshold value of the anomaly state counter;
when the first data amount reaches the predefined data amount and the first count value is greater than the normal ratio value, the monitoring unit accumulates the second count value and compares the second count value with the threshold value; and
when the second count value is greater than the threshold value, the monitoring unit determines that the application program is in the second anomaly state.

8. The anomaly detection device according to claim 7, further comprising:
a warning device, for issuing a warning when the second count value is greater than the threshold value.

9. The anomaly detection device according to claim 7, wherein the application program operates in a system platform, the system platform has a system state, and when the system state is a busy state, the monitoring unit determines whether the application program is in the first anomaly state or the second anomaly state according to the first data amount, the first count value and the second count value.

10. The anomaly detection device according to claim 9, wherein the system state has an update frequency, and the threshold value is set as greater than a number of times corresponding the update frequency.

11. An anomaly detection method, for detecting an anomaly in a usage state of an application program for a computing resource, the anomaly in the usage state comprises a first anomaly state and a second anomaly state, the anomaly detection method comprising the following steps:
accumulating a first data amount processed by the application program, by a data amount accumulation unit;
accumulating a first count value according to a first counting frequency, by an operation time counter;
selectively accumulating a second count value according to the first anomaly state, by an anomaly state counter; and
performing the following operations by a monitoring unit:
monitoring whether the first data amount reaches a predefined data amount, wherein the predefined data amount is related to a maximum processing rate of the application program;
when the first data amount reaches the predefined data amount, reading the first count value and determining whether the application program is in the first anomaly state according to the first count value; and
when it is determined that the application program is in the first anomaly state, accumulating and reading the second count value, and determining whether the application program is in the second anomaly state according to the second count value.

12. The anomaly detection method according to claim 11, wherein the first anomaly state indicates a short-term anomaly or a mild anomaly of the usage state, and the second anomaly state indicates a long-term anomaly or a severe anomaly of the usage state.

13. The anomaly detection method according to claim 11, wherein the step of determining whether the application program is in the first anomaly state according to the first count value comprising:
setting a normal ratio value of the operation time counter, by the monitoring unit;
when the first data amount reaches the predefined data amount, comparing the first count value with the normal ratio value, by the monitoring unit; and
when the first count value is greater than the normal ratio value, determining that the application program is in the first anomaly state, by the monitoring unit.

14. The anomaly detection method according to claim 13, wherein when the first count value is less than or equal to the normal ratio value, the application program reaches the maximum processing rate, and the monitoring unit determines that the application program is in a normal state.

15. The anomaly detection method according to claim 13, wherein the predefined data amount is equal to the maximum processing rate divided by the first counting frequency and then multiplied by the normal ratio value.

16. The anomaly detection method according to claim 15, wherein the monitoring unit estimates the maximum processing rate according to a statistical data of the application program.

17. The anomaly detection method according to claim 13, wherein the step of determining whether the application program is in the second anomaly state according to the second count value comprising:
setting a threshold value of the anomaly state counter, by the monitoring unit;
when the first data amount reaches the predefined data amount and the first count value is greater than the normal ratio value, accumulating the second count value and comparing the second count value with the threshold value, by the monitoring unit; and
when the second count value is greater than the threshold value, determining that the application program is in the second anomaly state, by the monitoring unit.

18. The anomaly detection method according to claim 17, further comprising:
when the second count value is greater than the threshold value, issuing a warning by a warning device.

19. The anomaly detection method according to claim 17, wherein the application program operates in a system platform, the system platform has a system state, and when the system state is a busy state, determining whether the application program is in the first anomaly state or the second anomaly state according to the first data amount, the first count value and the second count value, by the monitoring unit.

20. The anomaly detection method according to claim 19, wherein the system state has an update frequency, and the threshold value is set as greater than a number of times corresponding the update frequency.
